(19) United States
(12) Patent Application Publication
(10) Pub. No.: US 2021/0376733 A1
(43) Pub. Date: Dec. 2, 2021

(54) ENERGY EFFICIENT POWER SYSTEM

(71) Applicants: SANDEEP KUMAR CHINTALA, GREENFORD (GB); SRIRANJAN RASAKATLA, HYDERABAD (IN)

(72) Inventors: SANDEEP KUMAR CHINTALA, GREENFORD (GB); SRIRANJAN RASAKATLA, HYDERABAD (IN)

(21) Appl. No.: 17/047,104

(22) PCT Filed: Apr. 12, 2019
(86) PCT No.: PCT/GB2019/051063

§ 371 Date: Oct. 13, 2020

(30) Foreign Application Priority Data
Apr. 13, 2018 (IN) 201841014282

(51) Int. Cl. H02M 3/335; H02M 1/00; H02J 7/00

(52) U.S. Cl. CPC H02M 3/335; H02J 7/007; H02M 1/0003

(57) ABSTRACT

In an example, a power system (100) for generation and controlled distribution of power, comprises a transmitter circuit (108) coupled to a first rechargeable input DC source (106) to receive a DC-input power; a transmitter coil (102) coupled to the transmitter circuit (108) to receive an input voltage; a receiver coil (104) with magnets to induce a DC voltage in the receiver coil (104) based on the input voltage of the transmitter coil (102); a receiver circuit (116) coupled to the receiver coil (104) to receive the induced DC voltage; a DC-DC voltage converter (118) coupled to the receiver circuit (116) to receive and convert the induced DC voltage into a reduced DC voltage, which is supplied back to the first rechargeable input DC source (106); and a load unit (112) with a plurality of loads (114) coupled to the DC-DC voltage converter (118) to receive the reduced DC voltage.

### FIELD OF INVENTION

The present subject matter relates, in general, to energy systems, and particularly but not exclusively, to a power generation and distribution system.

### BACKGROUND

A transformer based energy system comprises a transformer, an input source and a load. The transformer based energy system uses one or more transformer to step-up or step-down the voltage level of an input power from the input source to a desired level in order to provide an output power to the load.

Transformers, in general, comprise a primary winding and a secondary winding. The difference in number of turns in the windings leads to stepping up or stepping down of the voltage. The voltage is applied to the primary winding and depending upon the number of turns of the secondary winding, a voltage is induced in the secondary coil due to magnetic induction.

### BRIEF DESCRIPTION OF DRAWINGS

The following detailed description references the drawings, wherein:

FIG. 1 illustrates an energy efficient power system, according to an example implementation of the present subject matter.

FIG. 2 illustrates another example implementation of the energy efficient power system.

FIG. 2a illustrates a cross section of the transmitter coil and receiver coil in an example implementation of the present subject matter.

FIG. 3 illustrates a yet another example implementation of the energy efficient power system.

FIG. 4 illustrates a system to control a load connected to the energy efficient power system, according to an example implementation of the present subject matter.

FIG. 5 illustrates a system to control the energy efficient power system, according to an example implementation of the present subject matter.

### DETAILED DESCRIPTION

A transformer steps up or steps down a voltage of the input power with an output power being equal to the input power. The current induced in a secondary winding of the transformer is proportionally changed in order to satisfy the requirement of equality of the input power and the output power. Also, transformers work only on alternating current (AC) and thus, the input and output of the transformers can only be an AC.

In the transformer based energy system, the transformer needs a continuous external input supply in order to provide an output. Further, as the output of the transformer is always an AC, the output of the transformer must be converted to DC whenever there is a requirement of DC power. The conversion process from AC to DC requires LC circuits or diode circuits which results in significant losses of electrical power.

The present subject matter provides an energy efficient power system which does not require an external input power source and further does not require a LC circuit or diode circuit for AC to DC conversion. The power system of the present subject matter comprises a transmitter coil and receiver coil wherein the transmitter coil and the receiver coil encloses magnets which provide strong magnetic field for magnetic induction.

The transmitter coil is provided with an input voltage wherein the input voltage is an oscillating waveform. In an example, a square wave may be provided to the transmitter coil. A square wave generator may be used to generate square voltage wave wherein the square wave generator takes input from a DC source, such as a battery. For producing other types of oscillating input waveform, a suitable waveform generator may be accordingly used.

The oscillating waveform inputted into the transmitter coil induces a voltage in the transmitter coil due to electromagnetic induction. The turns ratio of the transmitter coil and the receiver coil is such that the voltage is stepped up in the receiver coil. Further, due to the high magnetic field created due to the magnets, the waveform induced in the receiver coil gets rectified from AC to DC. Thus, a rectifier and LC circuit is not required to convert AC into DC and leading to reduction in losses. The magnetic field injects additional power into receiver coil of the transformer which steps ups the negative side of the waveform to the positive side to generate DC output power.

The DC output power from the receiver coil is received by a DC-DC converter which divides the high DC voltage into smaller voltage which can be used to run electrical loads and simultaneously can be used to charge the DC source, i.e., the abovementioned battery connected to the square wave generator for providing input to the transmitter coil.

In an example, two DC sources may be provided with the DC output power simultaneously. The first DC source may be the DC source, such as the battery used to provide power to the transmitter coil and in turn supply power to the loads while the second DC source may be another DC source, such as a battery or a semiconductor device that may store the DC output power. Accordingly, while one of the DC sources is being charged, the other DC source may be used to power the loads. Thus, the efficiency of the system increases as the DC sources are being recharged simultaneously. In an embodiment, the power stored in the DC source is being charged may be maintained at a predefined threshold. Once the DC source is being charged is sufficiently charges, DC source may be coupled to the transmitter to provide energy to the loads and the another DC source may be charged. In an example, the current for charging the batteries can be provided via a transistor. A transistor may be introduced between the DC-DC voltage converter and the input DC source. The transistor acts as an amplifier and amplifies the input current that it receives from the DC-DC voltage convertor. The amplified output current from the transistor is provided to the batteries during charging. Amplification of current by the transistor leads to fast charging of the batteries.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

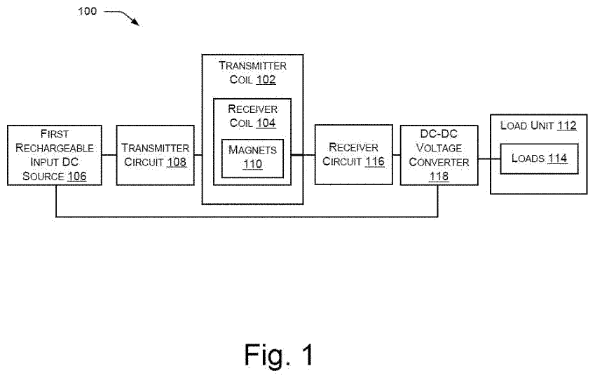

FIG. 1 illustrates a power system 100 in accordance with an example implementation of the present subject matter. The power system 100 includes a transmitter coil 102 and a receiver coil 104. The transmitter coil 102 is further coupled to a first rechargeable input DC source 106 and a transmitter circuit 108. The first rechargeable input DC source 106 provides a DC input power to the transmitter circuit 108 which in turn converts the DC voltage into an oscillating waveform voltage. In an example, where a square wave is to be generated, the transmitter circuit 108 may be a square wave generator. Further, the first rechargeable input DC source 106 may be a rechargeable battery, such as rechargeable Zinc—Carbon battery, Lithium-Ion battery, Nickel Cadmium (NiCd) battery, Nickel-Metal Hydride (NiMH) battery, Lead Acid battery, Lithium Polymer battery, capacitor battery, semiconductor battery, solid state batteries, graphene battery, solid state graphene battery, Aluminium-ion battery, vanadium redox battery, Zinc—bromine battery, Zinc—cerium battery, glass battery, lithium air battery, Nickle hydrogen battery, organic radical battery, polymer based battery, silicon air battery, super iron battery, Further, the transmitter coil 102 encloses magnets 110 which generates a strong magnetic field for electromagnetic induction and rectification.

Due to magnetic induction, voltage is induced, by the transmitter coil 102, in receiver coil 104. The number of turns of the winding of the transmitter coil 102 is less than the number of windings in the receiver coil 104 which results in stepping up of the voltage in the receiver coil 104. The induced voltage in the receiver coil 104 is converted from AC to DC due to the high magnetic field generated by the magnets 110.

In an example, the windings of the transmitter coil 102 and the windings of the receiver coil 104 may be a core type of shell type winding. Further, the windings can be a single-phase winding or three-phase star/delta winding depending upon the usage. The windings of the transmitter coil 102 and the windings of the receiver coil 104 may made up of copper or aluminum Further, in various examples, the winding of the transmitter coil 102 and receiver coil 104 may be made up of copper, aluminum, graphene, annealed copper, silver, other conductive metals, and alloys. Further, the windings of the transmitter coil 102 and the windings of the receiver coil 104 may include laminated steel core to reduce eddy current losses.

Further, in an example, the magnets 110 can be a neodymium magnet, a dipole magnet, an electromagnet, a field magnet, a plastic magnet, a programmable magnet, a quadrupole magnet, a sextupole magnet, a single-molecule magnet, a split a magnet, a superconducting magnet.

The power system 100 of the present subject matter further comprises a load unit 112 which comprises loads 114 that consume the electrical energy. As discussed above, in the receiver coil 104, a high voltage DC (as compared to the input voltage) is induced by the transmitter so coil 102. The high voltage DC is then provided to a receiver circuit 116. The receiver circuit 116 supplies the DC power to a DC-DC converter 118. The DC-DC converter 118 converts the high voltage DC into smaller DC voltages. In an example, the DC-DC voltage converter 118 may be a voltage divider. The smaller DC voltages as converted from the DC-DC voltage converter 118 is transferred to the loads 114 and is also supplied back to the first rechargeable input DC source 106. The loads 114 may be a LED load, a DC motor, an alarm or any such device which works on DC power. In an example, a diode may be placed between the DC-DC voltage converter 118 and the first rechargeable input DC source 106 to prevent back flow of power from the first rechargeable input DC source 106.

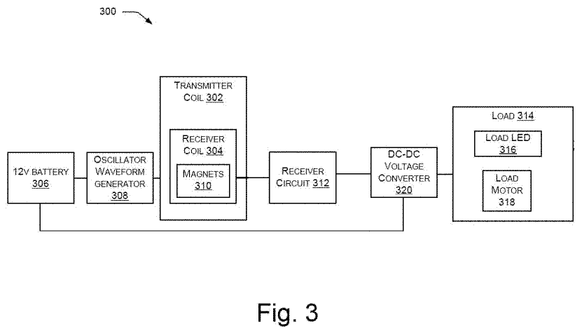

The DC voltage supplied back to the first rechargeable input DC source 106 recharges the first rechargeable input DC source 106. Thus, the power system 100 of the present subject works as power system 100 which is being continuously recharged. Further, as the output of the power system 100 of the present subject matter is also used to recharge the first rechargeable input DC source 106, the efficiency of the power system 100 of the present subject matter is more than the conventional transformer power system. The working of the power system 100 has been explained in detail with reference to FIG. 3.

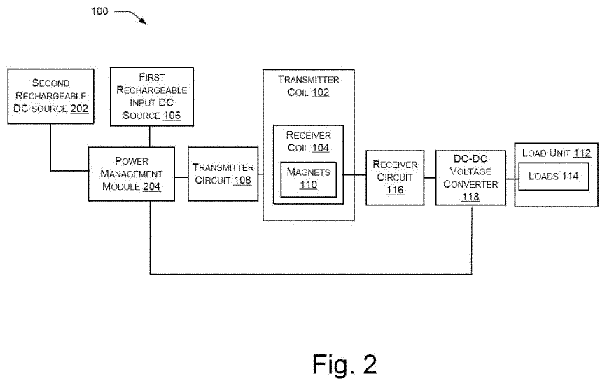

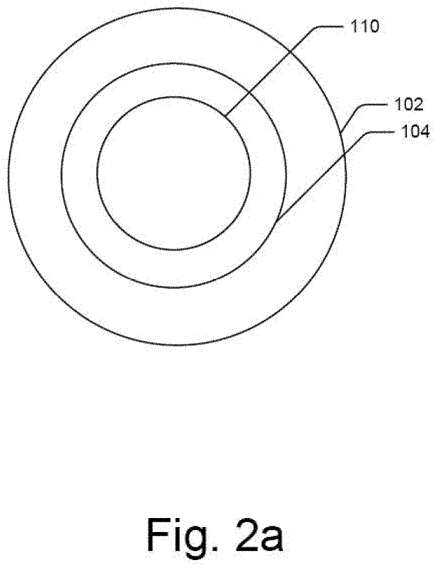

In another example and as illustrated in FIG. 2, the transmitter coil 102 may also be provided input through a second rechargeable input DC source 202 wherever required. In an example, when the input DC voltage is being provided through the first rechargeable input DC source 106, the second rechargeable input DC source 202 may be in a charging state. Further, when a power stored in the first rechargeable input DC source 106 falls below a certain threshold, the operation can be switched to the second rechargeable input DC source 202 and the first rechargeable input DC source 106 may be recharged. The switching from the first rechargeable input DC source 106 to the second rechargeable input DC source 202 may be performed using a power management module 204. The power management module 204 may be responsible for determining the power stored in the batteries and switching the batteries when the power stored in the batteries falls below the threshold. Further, in an example, the power management module 204 may comprise or may be coupled with an artificial intelligence engine (not shown) which further enhance the capability of the power system. Using artificial intelligence, the threshold can be dynamically determined on a case to case basis. By dynamically varying the threshold, the artificial intelligence engine provides for more efficient power management.

Further, in an example implementation, the current for charging the batteries can be provided via a transistor. A transistor may be introduced between the DC-DC voltage converter 118 and the first rechargeable input DC source 106 or the second rechargeable input DC source 202. The transistor acts an amplifier and amplifies the input current that it receives from the DC-DC voltage converter 118. The amplified output current from the transistor may be provided to the first rechargeable input DC source 106 or the second rechargeable input DC source 202 during charging. Amplification of current by the transistor leads to fast charging of the batteries.

In an example, implementation of the present subject matter, the transmitter coil 102 and the receiver coil 104 may be concentrically arranged as shown in FIG. 2a. FIG. 2a shows a cross sectional view of the concentric arrangement of the transmitter coil 102, receiver coil 104, the magnets 110. The magnets 110 may be housed in the center of the transmitter coil and the receiver coil 104. Although the transmitter coil 102, the receiver coil 104, and the magnets 110 is shown in a concentric shape, it is to be understood that the transmitter coil 102, the receiver coil 104, and the magnets 110 may be arranged in any other shapes, such as oblong, elliptical, rectangular.

FIG. 3 illustrates working of the power system 300 of the present subject matter. The power system 300 of the present subject matter includes a transmitter coil 302 and the receiver coil 304. The transmitter coil 302 and the receiver coil 304 are alike the transmitter coil 102 and the receiver coil 104, respectively. The transmitter coil 302 is coupled to a 12V battery 306 which provides an input to an oscillator waveform generator 308. The oscillator waveform generator 308 generates an oscillating waveform voltage and provide the same to transmitter coil 302. The transmitter coil 302 and the receiver coil 304 encloses magnets 310 which creates a strong magnetic field. The transmitter coil 302 is magnetically coupled with the receiver coil 304.

The number of turns of the transmitter coil 302 and the receiver coil 304 is such that the voltage induced in the receiver coil 304 is four times the voltage of the transmitter coil 302. Thus, in this case, the induced voltage in the receiver coil 304 is 48 volts (12 volts in transmitter coil 302). The magnets 310 creates a strong magnetic field such that the voltage induced in the transmitter coil 302 is a DC voltage. The induced DC voltage of 48 volts is supplied to a receiver circuit 312 which is similar to the receiver circuit 116.

The power system 300 further comprises a load 314 which comprises a load LED 316, a load motor 318, and a DC-DC converter 320. The receiver circuit 312 receives the 48 Volts of DC power from the receiver coil 304 and provides the same to the DC-DC converter 320. The DC-DC converter 320 divides the 48 Volts DC into smaller voltages which is turn is used to power the load LED 316 and the load motor 318. After providing power to the load LED 316 and the load motor 318, the remaining power is fed to the 12 Volts input battery 306. This recharges the 12 Volts input battery 306. Thus, the 12 Volts input battery 306 is continuously recharged with the output power and hence the efficiency of the system increases.

Further in an example, the power system 300 may comprise two batteries, for example a first battery and a second battery. In an example, when the transmitter coil 302 is receiving power through the first battery, the second battery may be in a charging state. While, when the capacity of the first battery falls below a certain threshold, the operation can be switched to the second battery and the first battery may be recharged. The switching from the first battery to the second battery may be performed using a power management module. The power management module may be responsible for determining the threshold capacity of first battery and the second battery and thereby switching the first battery and the second battery when the threshold capacity of the batteries (the first battery and the second battery) is satisfied. Further, in an example, the power management module may be coupled with an artificial intelligence engine which further enhance the capability of the power system 300. Using artificial intelligence, the threshold can be dynamically determined on a case to case basis. In an example, the batteries, i.e., the first battery and the second battery may be recharged via some renewable means to compensate for any deficient amount of power during operation of the power system 300. The renewable energy may be, such as solar energy, wind energy, tidal energy. In an another example, a conventional source of energy, such as coal, crude oil, hydroelectricity may also be used to compensate for any deficient amount of power during operation of the power system 300.

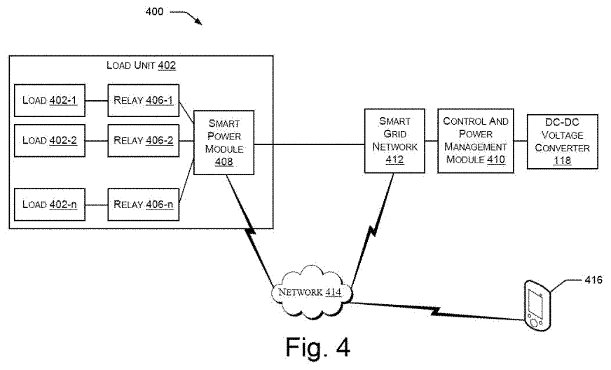

In an example implementation of the present subject matter, a load connected to a receiver may also be controlled through a wireless communication protocol. The wireless communication protocol may be a radio frequency link, a telemetry link, infrared link and other similar links. The operation of the load connected to the receiver may be controlled by a control and power management station. This has been explained with reference to FIG. 4.

FIG. 4 illustrates an example implementation of a power system 400 wherein the loads are controlled using wireless technology. The power system 400 comprises a load unit 402, a smart grid network 412, a control and power management module 410, and a DC-DC voltage converter 118. The load unit 402 is same as the load unit 112. The DC-DC voltage converter 118 receives power from the receiver coil (not shown), as explained in the FIG. 1-3. The load unit 402 comprises load 402-1, load 402-2, . . . , load 402-n. The load 402-1, load 402-2, . . . , load 402-n coupled with a relay 406-1, . . . , relay 406-2, . . . ,relay 406-n. Switching ON and OFF of the each of the load is controlled by the corresponding relay. The relay 406-1, relay 406-2, . . . , relay 406-n are coupled with a smart power module 408. In an load 402-1, load 402-2, . . . , load 402-n may the loads installed at the consumer end and the load 402-1, load 402-2, . . . , load 402-n of the consumer are coupled to the smart power module 408 via the 406-1, relay 406-2, . . . , relay 406-n. The loads (402-1 to 402-n) are same as the loads plurality of loads (114). It is to be understood that each consumer may have such arrangements. The load 402-1, load 402-2, . . . , load 402-n may be, such as a motor, LED array, a fan, a tube light and other such electrical loads.

The DC-DC converter 118 provides the DC power to the control and power management module 410 which in turn provides the power to smart grid network 412 for distribution. The smart grid network 412 distributes the DC to various load unit via a smart power module. For example, the smart grid network 412 transmits the DC power the load unit 402 via the smart power module 408.

The control and power management module 410 is responsible for managing the power system 400. The control and power management module 410 may monitor the power system and can be used to control the loads by providing commands to the smart grid network 412. The smart grid network 412 receives the command and transmits the commands to the smart power module 408. The smart power module 408 finally controls the load by operating the relay 406-1, relay 406-2, . . . , relay 406-n. In an example, relay 406-1, relay 406-2, . . . , relay 406-n may be an electromagnetic relays, solid state Relays, hybrid Relay, thermal relay, reed Relay etc. In an example, the network 414 may be a direct communication link or indirect communication link, such as be an internet, ethernet, Bluetooth network, radio network, infrared network and other such networks, The network 414 may be a single network or a combination of multiple networks and may use a variety of different communication protocols. Further, it is to be understood that the loads of a plurality of the consumers may be controlled via their respective smart power module 408. In an example, different types of data security protocol and encryption protocols can be used to protect the data exchange between the different entities.

When due to any limitations or fault in the power system, there is requirement of switching OFF the load 402-1 of the load unit 402, the control and power management module may issue commands to the smart grid network 412. The smart grid network 412 escalates the received command to the corresponding smart power module 408 via the network 414. The smart power module 408 initiates relay 406-1 such that the load 402-1 is switched OFF.

In an example, the smart power module 408 may also determine the amount of electricity consumed by a consumer. The consumer may pay the bills for the amount of electricity consumed through a web portal or mobile application. Each of the consumer may have a unique costumer identification and the consumer may pay the bills against his unique identification number. The consumer may pay the bills thorough a mobile 416. The mobile 416 may have an application for paying the bills. The consumer may login in the application using consumer ID and thereafter may pay the outstanding bills.

In an example, the control and power management module 410 may require controlling the load due to some power restrictions or in case of violation of the power utilization by a consumer. For example, if the consumer has not paid the bill, the electricity supply to the consumer can be cut off. After the consumer has paid the bills, the supply can be restored. As explained above, each of the consumers have a corresponding smart power module, such as the smart power module 408, the loads of the consumer can be controlled through the control and power management module 410 via the smart power module of the respective consumer.

Further, the power system 400 may also include voltage regulators to control the output voltage to be provided to the load unit 402. The voltage regulators may be included between the relay 406-1 and the load 402-1 or the relay 406-2 and the load 402-2 or the relay 406-3 and the load 402-3. The voltage regulators may be used to provide a constant output voltage as required by the load unit 402. Further, the voltage regulator may be a variable voltage regulator which can step up or step down the voltage level as required by a load in load unit 402.

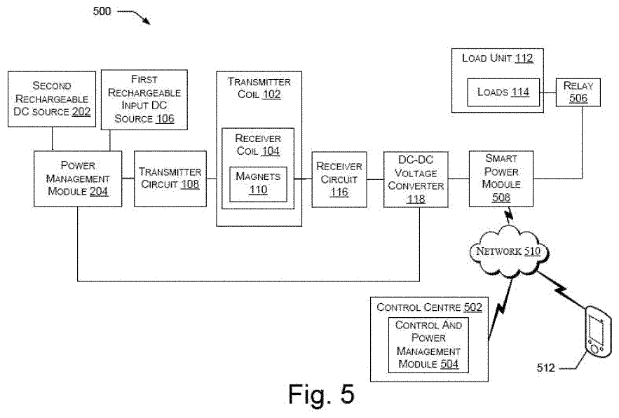

Further, in another example, the power system may have a separate control center for wirelessly controlling the loads. FIG. 5 shows an example implementation of such a power system, depicted as power system 500. In the figure, the power system 500 is shown with a separate control center 502. The control center 502 comprises a control and power management module 504, which transmits commands for wirelessly controlling the load 114. In one example implementation, the control and power management module 504 may be similar to the above-mentioned control and power management module 410. The load 114 is coupled to the DC-DC convertor 118 via a relay 506 and a smart power module 508. The smart power module 508, in one example, may be similar to smart power module 408 and measures the electricity consumption of the load unit 112. In an example, the load unit 112 may comprise a plurality of loads, however, only one load 114 is shown for simplicity of depiction. It is to be understood that the plurality of loads can be managed by the control and power management module 504 through their respective smart power module 508.

The smart power module 508 determines the energy consumption, bill details, of the load unit 112 and sends the energy consumption information and billing information to the control and power management module 504, via a network 510. In an example, the network 510, similar to network 414, may be a direct communication link or indirect communication link, such as be an internet, ethernet, Bluetooth network, radio network, infrared network and other such networks. The control and power management module 504 analyzes the energy consumption and the billing details of the load unit 112 to take proper action. In an example, when a customer having a load unit 112 does not pay the bill by due date, the control and power management module 504 may issue commands to the smart power module 508, via the network 510, to terminate the supply of electricity to the load unit 112. The smart power module 508 thereafter disconnects the load 114 within the load unit 112 by operating the relay 506. The relay 506 operates to disconnect the electrical supply to the load 114. Further, if a customer violates the energy consumption allotted to him, the control and power management module 504 may send commands to the smart power module 508 to disconnect the load 114 by operating the relay 506. In an example different types of data security protocol and encryption protocols can be used to protect the data exchange between entities of the preset subject matter.

Further, in an example, a customer may interface with the smart power module 508 over the network 510. Thus, the customer may log into his account via a portable device 512, such as smartphone, tablet, laptops. Each customer may have a unique identification number for logging into his account. The customer may log in into his account and may pay bills or monitor his usage.

In an example, the power system 100-500 may be used to generate and transmit power in the colonies that are planned to be developed on Mars. Controlling the loads through wireless technology may reduce the cost of installation of the power system in the newly developed colonies. Further, in an example, the power system 100-500 may be used in future colonies on moon and any other habitual planets in the universe. For example, the power system 100-500 may be implemented in future colonies in other recently discovered habitual planets, such as Kepler-186f, Kepler-62e, kepler-452b, Gliese 581g. Further, the current power system 100-500 may be used in proposed smart cities to wirelessly control the supply of power.

Although implementations for energy efficient power system have been described in a language specific to structural features and/or methods, it is to be understood that the invention is not necessarily limited to the specific features or methods described. Rather, the specific features and methods are disclosed as exemplary implementation for an energy efficient power system.

We claim:

1. A power system (100) for generation and controlled distribution of power, the power system (100) comprising:
a first rechargeable input DC source (106);
a transmitter circuit (108) coupled to the first rechargeable input DC source (106) to receive a DC-input power from the first rechargeable input DC source (106);
a transmitter coil (102) coupled to the transmitter circuit (108) to receive an input voltage from the transmitter circuit (108);
a receiver coil (104) comprising magnets to induce a DC voltage in the receiver coil (104) based on the input voltage of the transmitter coil (102);
a receiver circuit (116) coupled to the receiver coil (104) to receive the induced DC voltage;
a DC-DC voltage converter (118) coupled to the receiver circuit (116) to receive the induced DC voltage from the receiver circuit (116), and convert the induced DC voltage into a reduced DC voltage, which is supplied back to the first rechargeable input DC source (106); and
a load unit (112) with a plurality of loads (114) coupled to the DC-DC voltage converter (118) to receive the reduced DC voltage.

2. The system (100) according to claim 1, wherein the system (100) comprises:
a second rechargeable input DC source (202);
a power management module (204) coupled to the second rechargeable input DC source (202) and the first rechargeable input DC source (106) to select one of the first rechargeable input DC source (106) and the second rechargeable input DC source (202) to provide the DC-input power the transmitter circuit (108).

3. The system (100) according to claim 1, wherein the transmitter circuit (108) is an oscillator waveform generator.

4. The system (100) according to claim 1, wherein the first rechargeable input DC source (106) is a 12V rechargeable battery.

5. The system (100) according to claim 1, wherein the transmitter circuit (108) is a square waveform generator.

6. The system (100) according to claim 1, wherein the induced voltage is a stepped-up voltage.

7. The system (100) according to claim 1, wherein the system (100) comprises a diode placed between the DC-DC voltage converter (118) and the first rechargeable input DC source (106) to prevent the back-flow of the reduced DC voltage from the first rechargeable input DC source (106) to the DC-DC voltage converter (118).

8. The system (100) according to claim 1, wherein the system (100) comprises a transistor placed between the DC-DC voltage converter and the first rechargeable input DC source (106) to amplify the reduced DC voltage.

9. The system (100) according to claim 2, wherein the power management module (204) includes an artificial intelligence engine to determine the power stored in the first rechargeable input DC source (106) and the second rechargeable input DC source (202).

10. The system (100) according to claim 1, wherein the load unit (112) is wirelessly couplable to a smart grid network (412) and a control and power management module (410).

11. The system (100) according to claim 1, wherein the load unit (112) includes a smart power module (408) coupled to a plurality of relays (406-1 to 406-n) to switch ON and switch OFF the plurality of loads (114, 402-1 to 402-n) of the load unit (112).

12. The system (100) according to claim 1, wherein the DC-DC converter (118) is to provide the reduced DC voltage to the control and power management module (410), wherein the control and power management module (410) is to provide the reduced voltage DC to the smart grid network (412) to distribute the reduced voltage DC to the load unit (402).

13. A system (500) comprising:
a power management module (204) coupled to the second rechargeable input DC source (202) and the first rechargeable input DC source (106) to select one of the first rechargeable input DC source (106) and the second rechargeable input DC source (202) to provide the DC-input power the transmitter circuit (108);
a transmitter circuit (108) coupled to the power management module (204) to receive a DC-input power from the power management module (204);
a transmitter coil (102) coupled to the transmitter circuit (108) to receive an input voltage from the transmitter circuit (108);
a receiver coil (104) comprising magnets to induce a DC voltage in the receiver coil based on the input voltage of the transmitter coil (102);
a receiver circuit (116) coupled to the receiver coil (104) to receive the induced DC voltage;
a DC-DC voltage converter (118) coupled to the receiver circuit (116) to receive the induced DC voltage from the receiver circuit (116), and convert the induced DC voltage into a reduced DC voltage, which is supplied back to the first rechargeable input DC source (106); and
a smart power module (508) coupled to the DC-DC voltage converter (118) to receive the reduced DC voltage.

14. The system (500) according to claim 13, the system (500) comprising:
a control center (502) comprising a control and power management module (504) wirelessly coupled to the smart power module (508) to transmit a command for wirelessly controlling the loads (114) of the load unit via a relay (506).
